(19) United States
(12) Patent Application Publication
(10) Pub. No.: US 2024/0359234 A1
(43) Pub. Date: Oct. 31, 2024

(54) Method For Manufacturing Three-Dimensional Shaped Object

(71) Applicant: SEIKO EPSON CORPORATION, Tokyo (JP)

(72) Inventors: Akihiko TSUNOYA, Okaya (JP); Takayuki YOKOYAMA, Matsumoto (JP)

(21) Appl. No.: 18/645,540

(22) Filed: Apr. 25, 2024

(30) Foreign Application Priority Data
Apr. 26, 2023 (JP) 2023-072367

(51) Int. Cl. B22F 10/14; B22F 3/10; B22F 10/40; B33Y 10/00

(52) U.S. Cl. CPC B22F 10/14; B22F 3/1021; B22F 10/40; B33Y 10/00

(57) ABSTRACT

A method for manufacturing a three-dimensional shaped object includes: a step of stacking a layer containing a first inorganic powder and a first binder to form a first component, the first component being bonded to a second component containing a second inorganic powder and a second binder by a heat treatment; and a support body forming step of forming, by stacking the layer, a support body which is removed after the heat treatment. The heat treatment is executed on an aggregate. The support body is formed in the aggregate to support an overhang portion from below between the first component and the second component. The support body forming step includes: a step of forming a support main body portion by stacking the layer containing the first inorganic powder and the first binder; a step of forming a first contact portion in contact with the first component in the aggregate by stacking a layer containing a third inorganic powder having a melting point higher than that of the first inorganic powder and the second inorganic powder; and a step of forming a second contact portion in contact with the second component in the aggregate.

The present application is based on, and claims priority from JP Application Serial Number 2023-072367, filed Apr. 26, 2023, the disclosure of which is hereby incorporated by reference herein in its entirety.

### BACKGROUND

### 1. Technical Field

The present disclosure relates to a method for manufacturing a three-dimensional shaped object.

### 2. Related Art

JP-A-2022-101987 discloses a method for manufacturing a product by bonding a first component and a second component each containing an inorganic powder and a binder. In this method, the first component is generated by a three-dimensional shaping device, the first component and the second component are assembled to obtain an assembly, and then the assembly is degreased and sintered.

JP-A-2022-101987 is an example of the related art.

According to the method of JP-A-2022-101987, the product can be manufactured by bonding the first component and the second component using a simple method. However, for example, when the first component or the second component includes an overhang portion having no support on a lower side, the overhang portion is deformed due to an influence of gravity in a sintering step, and the product may not satisfy desired dimensional accuracy.

### SUMMARY

According to an aspect of the present disclosure, a method for manufacturing a three-dimensional shaped object is provided. The method for manufacturing a three-dimensional shaped object includes: a first component forming step of stacking a layer containing a first inorganic powder and a first binder to form a first component, the first component being bonded to a second component containing a second inorganic powder and a second binder by a heat treatment; and a support body forming step of forming, by stacking the layer, a support body, which is removed after the heat treatment, integrally with the first component. The heat treatment is executed on an aggregate in which the first component, the second component, and the support body are combined to be in contact with one another. In the aggregate, at least one of the first component and the second component includes an overhang portion overlapping with the other component from above, the overhang portion being spaced apart from the other component in a vertical direction. In the support body forming step, the support body is formed in the aggregate to support the overhang portion from below between the first component and the second component. The support body forming step includes: a first step of forming, by stacking the layer containing the first inorganic powder and the first binder, a support main body portion that is a portion of the support body being not in contact with the first component and the second component in the aggregate; a second step of forming, by stacking a layer containing a third inorganic powder, a first contact portion that is a portion of the support body being in contact with the first component in the aggregate; and third step of forming, by stacking the layer containing the third inorganic powder, a second contact portion that is a portion of the support body being in contact with the second component in the aggregate. A melting point of the third inorganic powder is higher than a melting point of the first inorganic powder and a melting point of the second inorganic powder.

### BRIEF DESCRIPTION OF THE DRAWINGS

FIG. 1 is a diagram showing a schematic configuration of a manufacturing system according to a first embodiment.

FIG. 2 is a diagram showing a schematic configuration of a hopper and a dispense unit provided in a three-dimensional shaping device.

FIG. 3 is a schematic perspective view showing a configuration of a groove forming surface side of a screw.

FIG. 4 is a top view showing a configuration of a screw facing surface side of a barrel.

FIG. 5 is a cross-sectional view showing a schematic configuration of an injection molding machine.

FIG. 6 is a process drawing showing a method for manufacturing a product according to the first embodiment.

FIG. 7 is a process drawing showing a method for shaping a first shaped object according to the first embodiment.

FIG. 8 is a process drawing showing a method for manufacturing a product according to a second embodiment.

FIG. 9 is a process drawing showing a method for manufacturing a first shaped object according to the second embodiment.

FIG. 10 is a process drawing showing a method for manufacturing a product according to a third embodiment.

FIG. 11 is a first diagram showing a method for manufacturing a second shaped object.

FIG. 12 is a second diagram showing a method for manufacturing the second shaped object.

FIG. 13 is a diagram showing a state in which a shaped object is shaped according to another embodiment.

### DESCRIPTION OF EMBODIMENTS

### A. First Embodiment

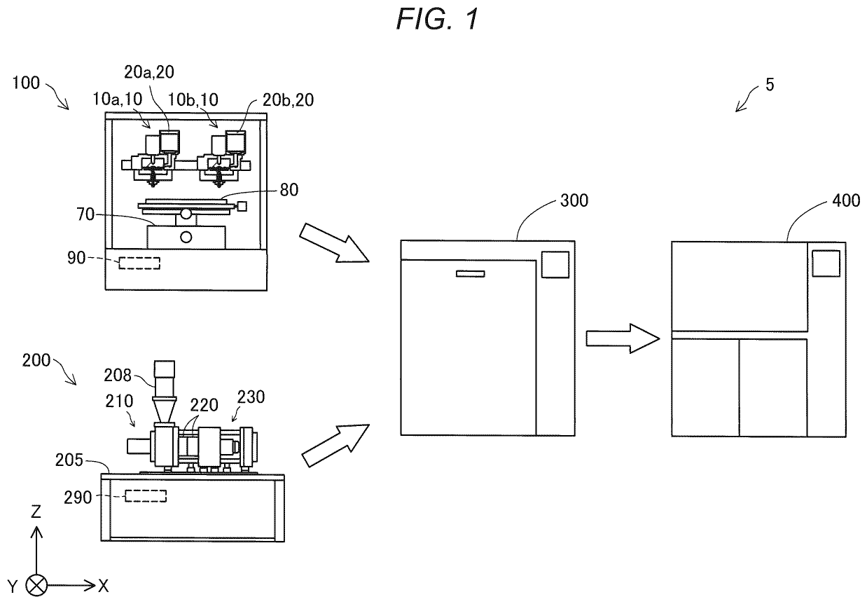

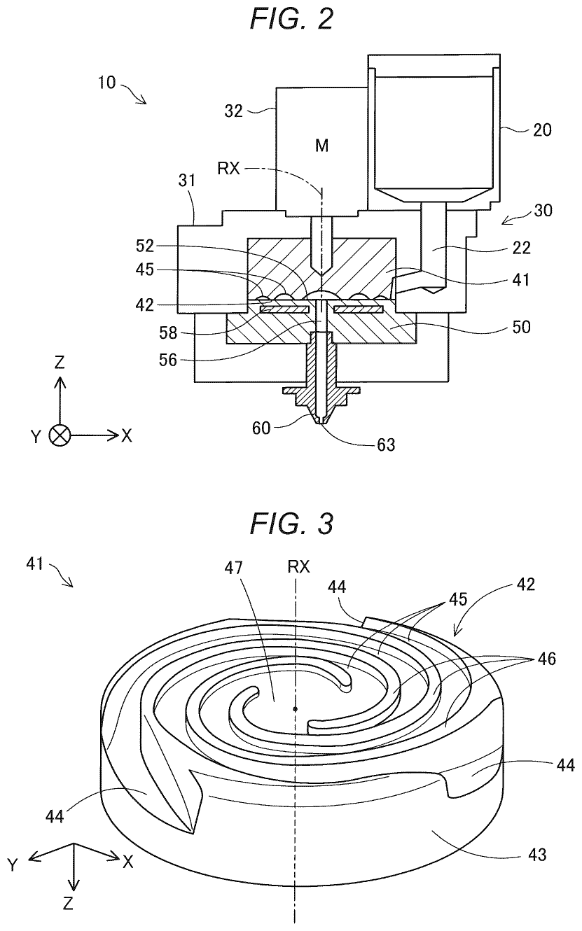

FIG. 1 is a diagram showing a schematic configuration of a manufacturing system 5 according to a first embodiment. The manufacturing system 5 includes a three-dimensional shaping device 100, an injection molding machine 200, a degreasing device 300, and a baking furnace 400. X, Y, and Z directions shown in FIG. 1 correspond to X, Y, and Z directions shown in FIG. 2 and thereafter. In the following description, when a direction is specified, a direction indicated by an arrow in each drawing is defined as “+” and an opposite direction is defined as “−”, and positive and negative signs are used in combination in a direction notation. Hereinafter, a +Z direction is also referred to as “up”, and a −Z direction is also referred to as “down”. A plane along the X direction and the Y direction is also referred to as an “XY plane”.

The three-dimensional shaping device 100 forms a three-dimensional shaped object containing a binder and an inorganic powder such as a metal or a ceramic by an additive manufacturing method. In the embodiment, the three-dimensional shaping device 100 forms, as the three-dimensional shaped object, a first shaped object including a first component and a support body. The injection molding machine 200 generates a second component containing a binder and an inorganic powder such as a metal or a ceramic by injection molding. The first component and the second component are portions forming a product after being subjected to baking described later. The support body is a portion that does not form a product and is removed before completion of the product.

The degreasing device 300 degreases the first shaped object and the second component by heating the first shaped object and the second component at a degreasing temperature. In the degreasing device 300, for example, the first shaped object and the second component are degreased in a state in which the first shaped object and the second component are placed on a setter made of a porous material. The setter may be provided with irregularities, grooves, or the like in order to reduce a contact area between the setter and the first shaped object or the second component. The baking furnace 400 heats an aggregate obtained by combining the first component, the second component, and the support body to be in contact with one another at a baking temperature higher than the degreasing temperature, thereby bonding the first component and the second component by sintering. In the heating by the baking furnace 400, for example, the above-described setter may be used. In the specification, heating for sintering the first component and the second component by the baking furnace 400 is also referred to as a heat treatment or baking. The support body is removed from the baked aggregate after the baking of the aggregate is completed. Accordingly, the support body is removed from the aggregate after the baking, thereby completing the product. In the specification, the term “product” means an article manufactured in the manufacturing system 5, and includes an article that is a part of another product and an article that is subjected to a post-treatment or processing after the support body is removed.

The three-dimensional shaping device 100 includes a first dispense unit 10a, a second dispense unit 10b, a first hopper 20a, a second hopper 20b, a movement mechanism unit 70, a shaping stage 80, and a control unit 90. Hereinafter, when the first dispense unit 10a and the second dispense unit 10b are not particularly distinguished from each other, they may be simply referred to as a dispense unit 10. Similarly, when the first hopper 20a and the second hopper 20b are not particularly distinguished from each other, they may be simply referred to as a hopper 20.

The movement mechanism unit 70 changes relative positions of the dispense unit 10 and the shaping stage 80. In the embodiment, the movement mechanism unit 70 moves the shaping stage 80 with respect to the first dispense unit 10a and the second dispense unit 10b. The movement mechanism unit 70 according to the embodiment is implemented by a three-axis positioner that moves the shaping stage 80 in three axial directions of the X, Y, and Z directions by drive forces of three motors. Each motor is driven under the control of the control unit 90. In another embodiment, the movement mechanism unit 70 may, for example, move the dispense unit 10 without moving the shaping stage 80, instead of moving the shaping stage 80. The movement mechanism unit 70 may move both the shaping stage 80 and the dispense unit 10.

The control unit 90 is implemented by a computer including one or more processors, a main storage device, and an input and output interface for inputting and outputting signals from and to the outside. In the embodiment, the control unit 90 exerts various functions such as a function of executing three-dimensional shaping processing of shaping the three-dimensional shaped object by the processor executing a program or a command read into a main storage device. By selectively using the first dispense unit 10a and the second dispense unit 10b, the control unit 90 can switch between two different materials to shape the three-dimensional shaped object. The control unit 90 may be implemented by a combination of a plurality of circuits instead of the computer.

FIG. 2 is a diagram showing a schematic configuration of the hopper 20 and the dispense unit 10 provided in the three-dimensional shaping device 100. The dispense unit 10 includes a plasticizing unit 30 and a nozzle 60. The material accommodated in the hopper 20 is supplied to the dispense unit 10. Under the control of the control unit 90, the dispense unit 10 plasticizes at least a part of the material supplied from the hopper 20 by the plasticizing unit 30 to generate a plasticized material, and dispenses the generated plasticized material from the nozzle 60 onto the shaping stage 80 for stacking. In the embodiment, the term “plasticize” is a concept including melting, and is to change from a solid state to a flowable state. Specifically, in a case of a material in which glass transition occurs, the term “plasticize” refers to setting a temperature of the material equal to or higher than a glass transition point. In a case of a material in which the glass transition does not occur, the term “plasticize” refers to setting the temperature of the material equal to or higher than a melting point.

The hopper 20 accommodates a pellet-shaped material containing a binder and an inorganic powder such as a metal or a ceramic. The material accommodated in the hopper 20 is supplied to the plasticizing unit 30 via a supply path 22 provided below the hopper 20 so as to couple the hopper 20 and the dispense unit 10. In the embodiment, the first hopper 20a accommodates a first material, and the second hopper 20b accommodates a third material. Therefore, the first material accommodated in the first hopper 20a is supplied to the first dispense unit 10a, and the third material accommodated in the second hopper 20b is supplied to the second dispense unit 10b.

The plasticizing unit 30 includes a screw case 31, a screw 41 accommodated in the screw case 31, a drive motor 32 for driving the screw 41, a barrel 50, and a heater 58. The barrel 50 is provided with a communication hole 56. The heater 58 is embedded in the barrel 50. The screw 41 according to the embodiment is a so-called flat screw and may be referred to as a “scroll”.

The screw 41 has a substantially cylindrical shape in which a height in a direction along a central axis RX thereof is smaller than a diameter. The screw 41 has a groove forming surface 42 in which screw grooves 45 are formed at a surface facing the barrel 50. The groove forming surface 42 faces a screw facing surface 52 of the barrel 50.

The drive motor 32 is coupled to a surface of the screw 41 opposite to the groove forming surface 42. The drive motor 32 is driven under the control of the control unit 90. The screw 41 rotates around the central axis RX by a torque generated by the rotation of the drive motor 32. The drive motor 32 may not be directly coupled to the screw 41, and for example, may be coupled to the screw 41 via a speed reducer.

The barrel 50 has the screw facing surface 52 facing the groove forming surface 42 of the screw 41. The communication hole 56 provided in the barrel 50 is formed along the central axis RX of the screw 41.

The nozzle 60 has a nozzle opening 63 at a tip end thereof. The nozzle opening 63 communicates with the communication hole 56 provided in the barrel 50. The nozzle 60 dispenses the material plasticized by the plasticizing unit 30 from the nozzle opening 63 toward the shaping stage 80.

FIG. 3 is a schematic perspective view showing a configuration of the groove forming surface 42 side of the screw 41. In FIG. 3, a position of the central axis RX of the screw 41 is indicated by a one-dot chain line. As described above, the screw grooves 45 are provided in the groove forming surface 42. A screw central portion 47 which is a central portion of the groove forming surface 42 of the screw 41 is implemented as a recess to which one end of the screw groove 45 is coupled. The screw central portion 47 faces the communication hole 56 of the barrel 50. The screw central portion 47 intersects the central axis RX.

The screw groove 45 of the screw 41 forms a so-called scroll groove. The screw grooves 45 extend spirally from the screw central portion 47 toward an outer periphery of the screw 41 in an arc shape. The screw grooves 45 may extend in an involute curve shape or a spiral shape. The groove forming surface 42 is provided with ridge portions 46 which form side wall portions of the screw grooves 45 and extend along the screw grooves 45. The screw grooves 45 continue to material introduction ports 44 formed in a side surface 43 of the screw 41. The material introduction port 44 is a portion that receives the material supplied from the hopper 20 via the supply path 22.

FIG. 3 shows an example of the screw 41 including three screw grooves 45 and three ridge portions 46. The number of the screw grooves 45 and the ridge portions 46 provided in the screw 41 is not limited to three, and only one screw groove 45 may be provided, or two or more screw grooves 45 may be provided. FIG. 3 shows an example of the screw 41 in which the material introduction ports 44 are formed at three positions. The number of the material introduction ports 44 provided in the screw 41 is not limited to three, and the material introduction ports 44 may be provided only at one position, or may be provided at two or more positions.

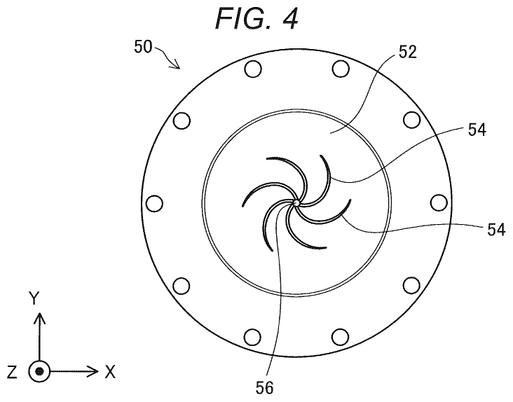

FIG. 4 is a top view showing a configuration of the screw facing surface 52 side of the barrel 50. As described above, the communication hole 56 is formed in a center of the screw facing surface 52. A plurality of guide grooves 54 are formed around the communication hole 56 in the screw facing surface 52. One end of each of the guide grooves 54 is coupled to the communication hole 56, and the guide grooves 54 extend spirally from the communication hole 56 toward an outer periphery of the screw facing surface 52. Each of the guide grooves 54 has a function of guiding the plasticized material to the communication hole 56. One end of the guide groove 54 may not be coupled to the communication hole 56. The guide groove 54 may not be formed in the barrel 50.

The description returns to FIG. 1. The injection molding machine 200 includes a plasticizing device 210 and a mold clamping device 230. The plasticizing device 210 and the mold clamping device 230 are fixed to a base 205. The base 205 includes a control unit 290. The injection molding machine 200 injects the plasticized material from the plasticizing device 210 into a mold 220 mounted on the mold clamping device 230 to mold a molded product. In the embodiment, the metal mold 220 is mounted on the mold clamping device 230. The mold 220 mounted on the mold clamping device 230 is not limited to being made of a metal, and may be made of a resin or ceramic. The mold 220 made of a metal is referred to as a metal mold.

The plasticizing device 210 is coupled to a material supply unit 208 into which the material of the molded product is charged. As the material of the molded product, a pellet-shaped material containing a binder and an inorganic powder such as a metal or a ceramic is used. In the embodiment, a second material is charged into the material supply unit 208. The plasticizing device 210 plasticizes at least a part of the material supplied from the material supply unit 208 to generate the plasticized material.

The control unit 290 is implemented by a computer including one or more processors, a main storage device, and an input and output interface for inputting and outputting signals from and to the outside. When the processor reads and executes a program on the main storage device, the control unit 290 controls the plasticizing device 210 and the mold clamping device 230 to manufacture the molded product.

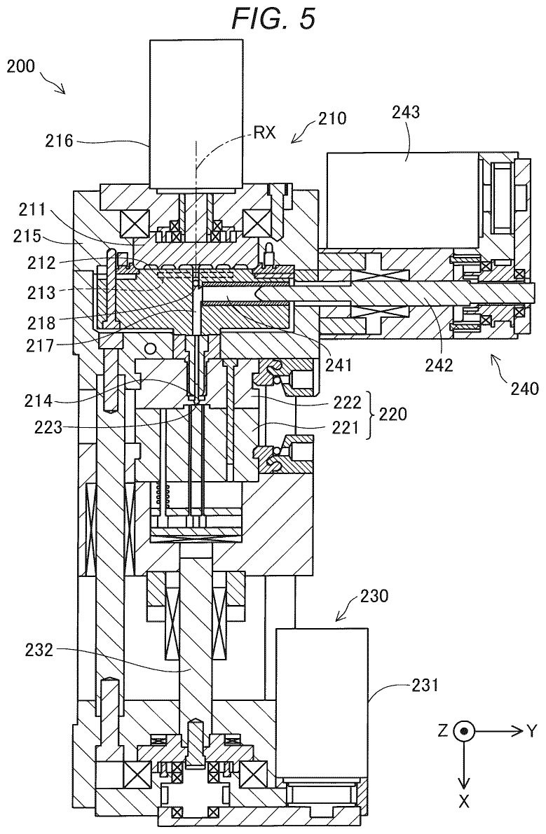

FIG. 5 is a cross-sectional view showing a schematic configuration of the injection molding machine 200. As described above, the injection molding machine 200 includes the plasticizing device 210, the mold clamping device 230, and the mold 220, and further includes an injection control mechanism 240.

The plasticizing device 210 includes a screw 211, a barrel 212, a heater 213, and a nozzle 214. The screw 211 is accommodated in an accommodating unit 215 that accommodates the screw 211. The screw 211 according to the embodiment is a so-called flat screw, and is also referred to as a “scroll”. The screw 211 is driven to rotate around the central axis RX in the accommodating unit 215 by a screw drive unit 216 including a drive motor. A communication hole 217 is formed in a center of the barrel 212. An injection cylinder 241 described later is coupled to the communication hole 217. The communication hole 217 is provided with a check valve 218 upstream of the injection cylinder 241. The rotation of the screw 211 by the screw drive unit 216 and the heating by the heater 213 are controlled by the control unit 290.

The injection control mechanism 240 includes the injection cylinder 241, a plunger 242, and a plunger drive unit 243 including a drive motor. The injection control mechanism 240 has a function of injecting the plasticized material in the injection cylinder 241 into a cavity 223 described later. The injection control mechanism 240 controls an injection amount of the plasticized material from the nozzle 214 under the control of the control unit 290. The injection cylinder 241 is a substantially cylindrical member coupled to the communication hole 217 of the barrel 212, and includes the plunger 242 therein. The plunger 242 slides inside the injection cylinder 241, and pressure-feeds the plasticized material in the injection cylinder 241 to the nozzle 214 provided in the plasticizing device 210. The plunger 242 is driven by the plunger drive unit 243.

The mold 220 includes a movable mold 221 and a fixed mold 222. The movable mold 221 and the fixed mold 222 are provided to face each other, and include the cavity 223, which is a space corresponding to a shape of the molded product, therebetween. The plasticized material flowing out of the communication hole 217 of the barrel 212 is pressure-fed to the cavity 223 by the injection control mechanism 240, and is injected from the nozzle 214.

The mold clamping device 230 includes a mold drive unit 231 including a drive motor, and has a function of opening and closing the movable mold 221 and the fixed mold 222. Under the control of the control unit 290, the mold clamping device 230 drives the mold drive unit 231 implemented by a motor to rotate a ball screw 232 and move the movable mold 221 coupled to the ball screw 232 with respect to the fixed mold 222 to open and close the mold 220.

As described above, in the embodiment, each of the three-dimensional shaping device 100 and the injection molding machine 200 includes a flat screw for plasticizing a material. Regarding this, the three-dimensional shaping device 100 and the injection molding machine 200 may each include an inline screw for plasticizing a material.

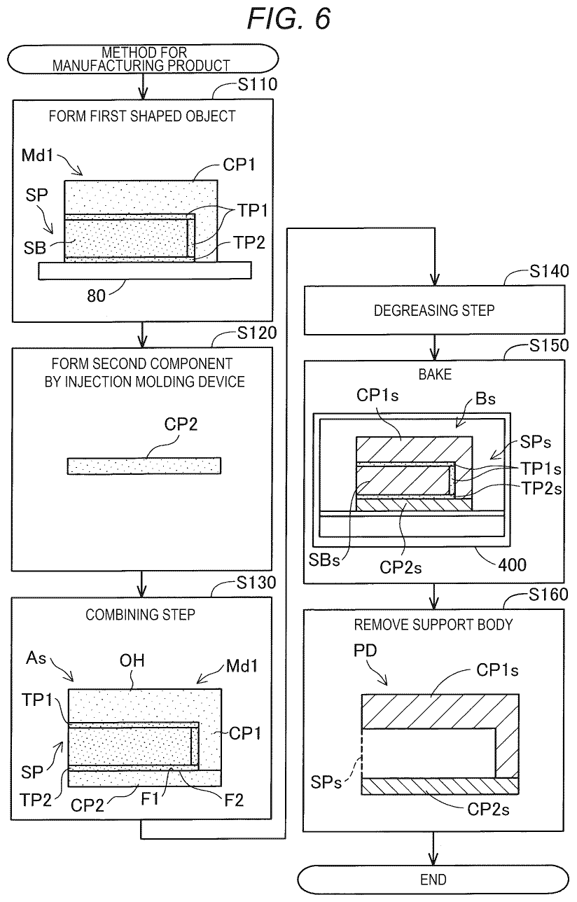

FIG. 6 is a process drawing showing a method for manufacturing a product PD according to the first embodiment. In step S110, the three-dimensional shaping device 100 forms a first shaped object Md1 that is a three-dimensional shaped object. The first shaped object Md1 includes a first component CP1 and a support body SP described above. The support body SP includes a support main body portion SB, a first contact portion TP1, and a second contact portion TP2. The first component CP1 and the support main body portion SB contain a first inorganic powder and a first binder. The first contact portion TP1 and the second contact portion TP2 contain a third inorganic powder and a third binder. In step S110 according to the embodiment, the first material containing the first inorganic powder and the first binder is used for forming the first component CP1 and the support main body portion SB, and the third material containing the third inorganic powder and the third binder is used for forming the first contact portion TP1 and the second contact portion TP2. In step S110, the first component CP1 and the support body SP are integrally formed.

In step S120, a second component CP2 containing a second inorganic powder and a second binder is molded by the injection molding machine 200. In step S120 according to the embodiment, the second material containing the second inorganic powder and the second binder is used for molding the second component CP2. Shapes of the first component CP1, the second component CP2, and the support body SP are not limited to the shapes shown in FIG. 6, and may be various shapes. An order of step S110 and step S120 is free, and may be, for example, simultaneous. Details of step S110 will be described later.

In the embodiment, a mass ratio of the first inorganic powder to the first binder in the first material is different from a mass ratio of the second inorganic powder to the second binder in the second material. More specifically, in the embodiment, the mass ratio of the first inorganic powder to the first binder in the first material is larger than the mass ratio of the second inorganic powder to the second binder in the second material.

In the embodiment, the first inorganic powder and the second inorganic powder are each made of an inorganic material containing the same element as a main component. More specifically, the first inorganic powder is made of SUS630, which is precipitation hardening stainless steel. The second inorganic powder is made of SUS316L, which is austenitic stainless steel. The main component means a main element of the inorganic powder, and means an element whose mass fraction in the inorganic powder is 50% or more. In the embodiment, a particle size of the first inorganic powder is different from a particle size of the second inorganic powder. In the embodiment, the particle size means a median diameter calculated based on a measurement result by a dynamic light scattering method. More specifically, in the embodiment, the particle size of the first inorganic powder is smaller than the particle size of the second inorganic powder.

A melting point of the third inorganic powder is higher than melting points of the first inorganic powder and the second inorganic powder. In the embodiment, the third inorganic powder is made of a ceramic material having a melting point higher than the melting points of the first inorganic powder and the second inorganic powder. As the third inorganic powder, for example, aluminum oxide or aluminum nitride can be used.

In another embodiment, the first inorganic powder and the second inorganic powder are not limited to SUS, and a single metal such as magnesium (Mg), iron (Fe), cobalt (Co), chromium (Cr), aluminum (Al), titanium (Ti), copper (Cu), and nickel (Ni), or an alloy containing one or more of these metals, or an alloy such as maraging steel, cobalt-chromium molybdenum, a titanium alloy, a nickel alloy, an aluminum alloy, a cobalt alloy, and a cobalt-chromium alloy may be used. The first inorganic powder and the second inorganic powder are not limited to metals, and oxide ceramics such as silicon dioxide, titanium dioxide, aluminum oxide, and zirconium oxide, and non-oxide ceramics such as aluminum nitride and silicon nitride may be used. Similarly, the third inorganic powder may be made of various ceramic materials or various metal materials as long as the melting point of the third inorganic powder is higher than the melting points of the first inorganic powder and the second inorganic powder.

In the embodiment, the first binder, the second binder, and the third binder each contain a resin and a wax. Examples of the resin used for each binder include polystyrene resin (PS), polyethylene resin (PE), polypropylene resin (PP), polyacetal resin (POM), polyvinyl chloride resin (PVC), polyamide resin (PA), acrylonitrile butadiene styrene resin (ABS), polylactic acid resin (PLA), polyphenylene sulfide resin (PPS), polycarbonate (PC), general-purpose engineering plastics such as modified polyphenylene ether, polybutylene terephthalate, and polyethylene terephthalate, and thermoplastic resins such as polysulfone, polyether sulfone, polyphenylene sulfide, polyarylate, polyimide, polyamide, polyether imide, and polyether ether ketone (PEEK). The first binder and the second binder may be the same binder or different binders. The third binder may be the same binder as the first binder or the second binder, or may be a different binder.

In step S130, the first component CP1, the second component CP2, and the support body SP are combined so as to be in contact with one another, thereby forming an aggregate As. A step of combining the first component CP1, the second component CP2, and the support body SP as in step S130 is also referred to as a combining step. In the aggregate As, at least one of the first component CP1 and the second component CP2 has an overhang portion OH, which is a portion spaced apart from the other component in a vertical direction and overlapping the other component from above. The overhang portion OH of one of the first component CP1 and the second component CP2 is a projecting portion, which is floated with respect to the other component and which is not supported on the lower side. In the specification, the meaning of the overhang portion OH includes a bridge portion which is a portion having a bridge shape. In the embodiment, the first component CP1 includes the overhang portion OH. That is, the overhang portion OH according to the embodiment is a portion that is spaced apart from the second component CP2 in the vertical direction and overlaps with the second component CP2 from above. In step S130, the aggregate As is formed by combining the first shaped object Md1 and the second component CP2 such that the first component CP1, the support body SP, and the second component CP2 are in contact with one another and either the first component CP1 or the second component CP2 includes the overhang portion OH. In step S130 according to the embodiment, the first shaped object Md1 and the second component CP2 are combined with each other by a robot (not shown) to form the aggregate As.

In step S140, the first shaped object Md1 and the second component CP2 are degreased by heating the first shaped object Md1 and the second component CP2 in the degreasing device 300. In step S140 according to the embodiment, the aggregate As is heated in the degreasing device 300. In step S150, the aggregate As is baked in the baking furnace 400 by heating the aggregate As degreased in step S140. Hereinafter, the baked aggregate As is also referred to as a baked product Bs. In step S150 of FIG. 6, a state immediately after the baking of the aggregate As is completed, more specifically, a state of the baked product Bs in the baking furnace 400 is shown. The baked product Bs includes a first baked component CPIs that is the baked first component CP1, a second baked component CP2s that is the baked second component CP2, and a baked support body SPs. As shown in FIG. 6, the aggregate As is heated in the baking furnace 400 while maintaining the same posture until the baking is completed, that is, until the baked product Bs is generated in the baking furnace 400. Hereinafter, this posture is also referred to as a heating posture. The aggregate As is formed to take the same posture as the heating posture. In step S160, the baked support body SPs is removed from the baked product Bs. In step S160 of FIG. 6, the removed support body SPs is indicated by a broken line. By removing the support body SPs from the baked product Bs, the product PD is completed. Details of steps S140 to S160 will be described later.

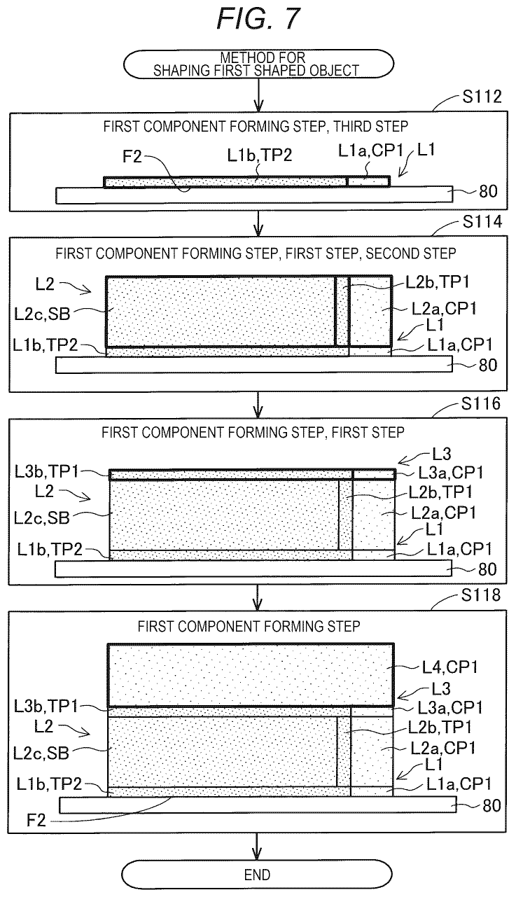

FIG. 7 is a process drawing of a method for shaping the first shaped object Md1 executed in step S110 of FIG. 6. FIG. 7 shows a method for manufacturing the three-dimensional shaped object according to the embodiment. The manufacturing method shown in FIG. 7 includes a first component forming step of forming the first component CP1 and a support body forming step of forming the support body SP integrally with the first component CP1. The support body forming step includes a first step of forming the support main body portion SB, a second step of forming the first contact portion TP1, and a third step of forming the second contact portion TP2. In the embodiment, the first shaped object Md1 is formed to take the same posture as the heating posture on the shaping stage 80.

In the first component forming step, the first component CP1 is formed by stacking a layer containing the first inorganic powder and the binder. In the first component forming step according to the embodiment, the control unit 90 of the three-dimensional shaping device 100 causes the plasticizing unit 30 to plasticize the first material and causes the first dispense unit 10a to dispense the plasticized first material, thereby stacking a layer of the plasticized first material on the shaping stage 80. Hereinafter, such a layer of the plasticized first material is also simply referred to as a layer of the first material.

In the support body forming step, the support body SP is formed to support the overhang portion OH from below between the first component CP1 and the second component CP2 in the aggregate As formed in the later step S130. The support main body portion SB formed in the first step is a portion of the support body SP that is in contact with neither the first component CP1 nor the second component CP2 in the aggregate As. The first contact portion TP1 formed in the second step is a portion in the aggregate As that is in contact with the first component CP1, and is positioned between the support main body portion SB and the first component CP1. The second contact portion TP2 formed in the third step is a portion in the aggregate As that is in contact with the second component CP2, and is positioned between the second component CP2 and the support main body portion SB in the aggregate As. A portion of the support body SP that is in contact with both the first component CP1 and the second component CP2 is the first contact portion TP1 and the second contact portion TP2.

In the first step, the support main body portion SB is formed by stacking the layer containing the first inorganic powder and the binder. In the first step according to the embodiment, the control unit 90 causes the first dispense unit 10a to dispense the plasticized first material, thereby stacking the layer of the first material on the shaping stage 80. In the second step, the first contact portion TP1 is formed by stacking a layer containing the third inorganic powder. In the third step, the second contact portion TP2 is formed by stacking the layer containing the third inorganic powder. In the second step and the third step according to the embodiment, the control unit 90 causes the plasticizing unit 30 to plasticize the third material containing the third inorganic powder and the third binder and causes the second dispense unit 10b to dispense the plasticized third material, thereby stacking the layer of the plasticized third material on the shaping stage 80. Hereinafter, such a layer of the plasticized third material is also simply referred to as a layer of the third material.

As shown in FIG. 7, the first shaped object Md1 is formed by appropriately executing the first component forming step, the first step, the second step, and the third step. In FIG. 7, the layers formed in the steps are indicated by thick lines. In step S112, a first layer L1 among the layers forming the first shaped object Md1 is formed at an upper surface of the shaping stage 80. The first layer L1 includes a layer portion L1a corresponding to a portion of the first component CP1 and a layer portion L1b corresponding to the second contact portion TP2, and is formed by executing the first component forming step and the third step. In step S114, a second layer L2 is formed at an upper surface of the first layer L1. The second layer L2 includes a layer portion L2a corresponding to a portion of the first component CP1, a layer portion L2b corresponding to the first contact portion TP1, and a layer portion L2c corresponding to the support main body portion SB, and is formed by executing the first component forming step, the first step, and the second step. More specifically, in step S114, the layer portion L2a is stacked on the layer portion L1a, and the layer portion L2b and the layer portion L2c are stacked on the layer portion L1b. In step S116, a third layer L3 is formed at an upper surface of the second layer L2. The third layer L3 includes a layer portion L3a corresponding to a portion of the first component CP1 and a layer portion L3b corresponding to the first contact portion TP1, and is formed by executing the first component forming step and the first step. More specifically, in step S116, the layer portion L3a is stacked on the layer portion L2a, and the layer portion L3b is stacked on the layer portion L2b and the layer portion L2c. In step S118, a fourth layer L4 is formed at an upper surface of the third layer L3. The fourth layer L4 is a layer corresponding to a portion of the first component CP1, and is formed by executing the first component forming step. The fourth layer L4 is stacked on the layer portion L3a and the layer portion L3b. Each of the first layer L1 to the fourth layer L4 may include only one layer in a stacking direction, or may include two or more layers in the stacking direction.

By executing each step shown in FIG. 7, the second contact portion TP2 is formed such that one surface F2 thereof is in contact with the upper surface of the shaping stage 80, and the support main body portion SB is in contact with the second contact portion TP2 from above, that is, in contact with the other surface of the second contact portion TP2. Accordingly, the one surface F2 is formed in a planar shape along the upper surface of the shaping stage 80. As shown in FIG. 6, the one surface F2 is in contact with a contact surface F1 of the second component CP2 in the aggregate As. The contact surface F1 has a planar shape similarly to the one surface F2.

The description returns to FIG. 6. In step S140 according to the embodiment, the aggregate As is heated at the degreasing temperature. The degreasing temperature according to the embodiment includes a first temperature and a second temperature higher than the first temperature. More specifically, in step S140, the aggregate As is heated at the first temperature and then further heated at the second temperature. The first temperature is a temperature for removing a wax component contained in the first shaped object Md1 and the second component CP2, and is, for example, 110° C. The second temperature is a temperature for removing a resin component contained in the first shaped object Md1 and the second component CP2, and is, for example, a temperature of 400° C. or higher and 500° C. or lower.

In step S150, the aggregate As on which the degreasing is completed in step S140 is heated at the baking temperature by the baking furnace 400. The baking temperature is high enough to sinter the first component CP1, the second component CP2, and the support main body portion SB. The baking temperature is more preferably low enough to prevent the first contact portion TP1 and the second contact portion TP2 from being sintered. The baking temperature according to the embodiment is, for example, 1200° C. In step S150, in the baked product Bs, a sintered portion is hatched with oblique lines, and an unsintered portion is hatched with a dot pattern. As shown in FIG. 6, in step S150 according to the embodiment, while a baked support main body portion SBs is sintered, a baked first contact portion TP1s and a baked second contact portion TP2s are not sintered. In step S160, the baked support body SPs can be removed by, for example, contact of a tool with the support body SPs or vibration. Such removal of the support body SPs is performed by, for example, a robot (not shown).

The method for manufacturing the three-dimensional shaped object in the embodiment described above includes the support body forming step of forming the support body SP, which is removed after baking the aggregate As in which the first component CP1, the second component CP2, and the support body SP are combined, integrally with the first component CP1. In the support body forming step, the support body SP is f formed to support the overhang portion OH from below between the first component CP1 and the second component CP2 in the aggregate As. The support body forming step includes the first step of forming the support main body portion SB which is a portion in the aggregate As that in not contact with the first component CP1 and the second component CP2, the second step of forming the first contact portion TP1 which is a portion in the aggregate As that is in contact with the first component CP1, and the third step of forming the second contact portion TP2 which is a portion in the aggregate As that is in contact with the second component CP2. The melting point of the third inorganic powder contained in the first contact portion TP1 and the second contact portion TP2 is higher than the melting point of the first inorganic powder contained in the first component CP1 and the support main body portion SB and the melting point of the second inorganic powder contained in the second component CP2.

According to the embodiment, the support body SP can be formed integrally with the first component CP1 to support the overhang portion OH in the aggregate As. Since the support main body portion SB contains the first inorganic powder similarly to that of the first component CP1, the sintering of the first component CP1 and the support main body portion SB can satisfactorily progress during the baking. Therefore, the overhang portion OH can be effectively supported by the support body SP during the baking. On the other hand, since the first contact portion TP1 and the second contact portion TP2 contain the third inorganic powder having the melting point higher than the melting points of the first inorganic powder and the second inorganic powder, compared to the first component CP1 and the second component CP2, the sintering is less likely to progress during the baking. Therefore, bonding between the first contact portion TP1 and the first component CP1 and bonding between the second contact portion TP2 and the second component CP2 during the baking are prevented. Accordingly, in the embodiment, the first component CP1 and the second component CP2 can be bonded by sintering while maintaining a state in which the overhang portion OH is effectively supported by the support body SP. After the first component CP1 and the second component CP2 are bonded, the support body SPs can be easily removed to obtain the product PD. Therefore, it is possible to prevent a decrease in dimensional accuracy of the product PD due to deformation of the overhang portion OH during baking.

In the embodiment, since the second component CP2 is molded by the injection molding machine 200, it is difficult to form the second component CP2 into a large shape, but the second component CP2 can be formed into a small and complicated shape without using a support material or the like, compared to the first component CP1 formed by the three-dimensional shaping device 100. Therefore, by combining the second component CP2 with the first component CP1, the products PD having more various shapes can be manufactured. Since the second component CP2 can be generated in a short time, the product PD can be manufactured more efficiently.

In the embodiment, in the third step, the second contact portion TP2 is formed such that the one surface F2 of the second contact portion TP2 is in contact with the upper surface of the shaping stage 80. In the first step, the support main body portion SB is formed at the formed second contact portion TP2. The second contact portion TP2 is in contact with the second component CP2 via the one surface F2 in the aggregate As. Accordingly, in the third step, the one surface F2 of the second contact portion TP2 can be formed in a planar shape along the upper surface of the shaping stage 80. In the aggregate As, the second contact portion TP2 is in contact with the second component CP2 via the one surface F2. More specifically, in the aggregate As, the one surface F2 is in contact with the contact surface F1 of the second component CP2. Therefore, the second component CP2 can be effectively supported by the support body SP during the sintering. In particular, in the embodiment, as shown in FIG. 7, a contact surface of the first component CP1 with respect to the second component CP2 is also formed at the upper surface of the shaping stage 80. A contact surface of the second component CP2 with respect to the first component CP1 has a planar shape. Therefore, the first component CP1 and the second component CP2 can be satisfactorily bonded by the sintering while the second component CP2 is effectively supported by the support body SP.

In the embodiment, since the first inorganic powder and the second inorganic powder are each made of the inorganic material containing the same element as the main component, the first component CP1 and the second component CP2 can be bonded to each other without using solder or the like in a bonding portion between the first component CP1 and the second component CP2. Therefore, it is possible to prevent a decrease in strength of the bonding portion of the product PD.

In the embodiment, the first inorganic powder and the second inorganic powder are made of different types of stainless steel powders. When the first inorganic powder and the second inorganic powder are made of different inorganic materials, the material used for forming the first component and the material used for forming the second component can be optimized. More specifically, in the embodiment, a material containing an inorganic powder more suitable for forming the first component by the three-dimensional shaping device 100 can be selected as the first material, and a material containing an inorganic powder more suitable for molding the second component by the injection molding machine 200 can be selected as the second material.

In the embodiment, the mass ratio of the first inorganic powder to the first binder in the first material used for forming the first component CP1 is different from the mass ratio of the second inorganic powder to the second binder in the second material used for forming the second component CP2. Accordingly, a mass ratio of an inorganic powder to a binder in a material used for forming each component can be optimized according to a shape, a size, a forming method, or the like of each component. For example, in the embodiment, a material having a mass ratio more suitable for forming the first component by the three-dimensional shaping device 100 can be selected as the first material, and a material having a mass ratio more suitable for molding the second component by the injection molding machine 200 can be selected as the second material.

In the embodiment, the particle size of the first inorganic powder is different from the particle size of the second inorganic powder. Accordingly, thermal shrinkage amounts of the first component CP1 and the second component CP2 during the sintering can be adjusted by adjusting the particle sizes of the inorganic powders. For example, in the embodiment, the particle size of the first inorganic powder is smaller than the particle size of the second inorganic powder. In the injection molding machine 200, a shaped object is formed by injecting a material into the mold 220 at a high pressure. Therefore, even when the same material is used in the injection molding machine 200 and the three-dimensional shaping device 100, a filling rate of the inorganic powder in the shaped object by the injection molding machine 200 is usually smaller than a filling rate of the inorganic powder in the shaped object by the three-dimensional shaping device 100. In this case, during the sintering, a thermal shrinkage rate of the shaped object by the three-dimensional shaping device 100 is larger than a thermal shrinkage rate of the shaped object by the injection molding machine 200. By reducing the particle size of the first inorganic powder as described above, the first component CP1 can be filled with the first inorganic powder at a higher density. Therefore, the thermal shrinkage amount of the first component CP1 during baking can be reduced, and the sintering of the first component CP1 and the second component CP2 and the bonding of the first component CP1 and the second component CP2 can be more satisfactorily progressed.

In the embodiment, the first component CP1 and the support main body portion SB are formed using the same first material. Therefore, the number of types of materials used in the three-dimensional shaping device 100 can be reduced as compared with a case where the first component CP1 and the support main body portion SB are formed of different materials. Since the number of types of materials to be used can be reduced, for example, the number of times of switching the nozzle 60 in the three-dimensional shaping device 100 can be reduced, and the possibility that a shaping time of the three-dimensional shaped object can be shortened increases.

### B. Second Embodiment

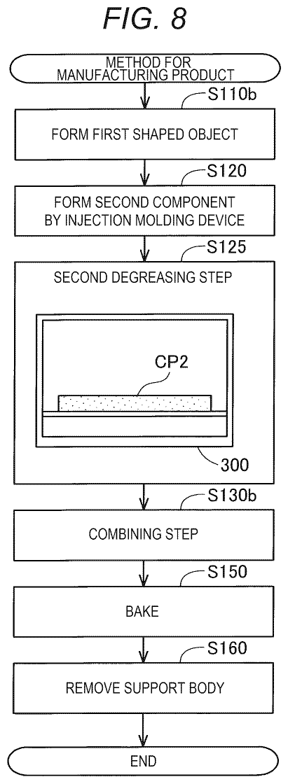

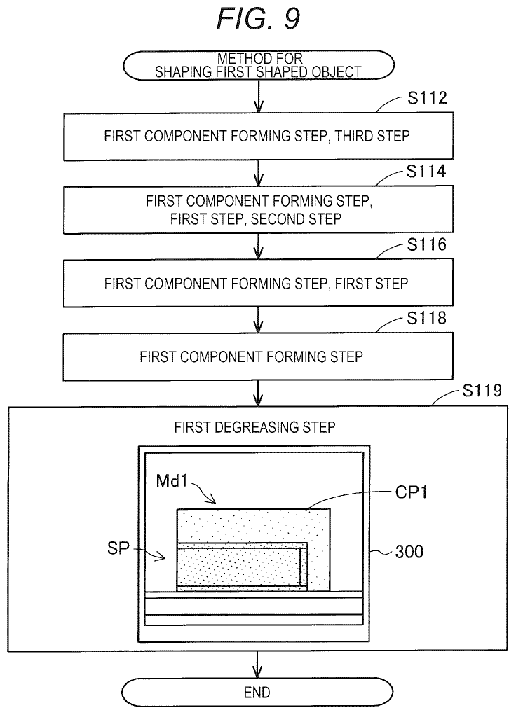

FIG. 8 is a process drawing showing a method for manufacturing a product according to a second embodiment. FIG. 9 is a diagram showing a method for manufacturing the first shaped object Md1 executed in step S110b of FIG. 8. In FIG. 8, the same steps as those in FIG. 6 are denoted by the same reference signs. In FIG. 9, the same steps as those in FIG. 7 are denoted by the same reference signs. In step S110b of FIG. 8, the first shaped object Md1 is formed by executing the manufacturing method shown in FIG. 9 in substantially the same manner as in the first embodiment. Unlike the first embodiment, the method for manufacturing the first shaped object Md1 according to the embodiment includes a step of removing the binder contained in the first component CP1 and the binder contained in the support body SP by heating before the aggregate As is formed. Specifically, the method for manufacturing the first shaped object Md1 shown in FIG. 9 includes a first degreasing step of step S119 as this step. In the manufacturing system 5 according to the second embodiment, portions not particularly described are the same as those of the first embodiment.

In the first degreasing step of step S119, the first component CP1 and the support body SP integrally formed with the first component CP1 are heated at a degreasing temperature by the degreasing device 300. By executing step S119, the binder contained in the first component CP1 and the support body SP is removed.

In step S125 of FIG. 8, a second degreasing step is executed. The second degreasing step is a step of degreasing the second component CP2 that is not combined with the first shaped object Md1. In step S125 according to the embodiment, the second component CP2 is heated at the degreasing temperature by the degreasing device 300, and the binder contained in the second component CP2 is removed. In another embodiment, for example, the first degreasing step and the second degreasing step may be executed simultaneously. In this case, the first degreasing step and the second degreasing step may be degreased by the same degreasing device 300, or may be degreased by different degreasing devices when a plurality of degreasing devices are provided in the manufacturing system 5. For example, the second degreasing step may be executed prior to the first degreasing step.

In step S130b, unlike step S130 of FIG. 6, the first shaped object Md1 and the second component CP2 on which the degreasing is completed are combined. Therefore, the degreasing step is not executed after step S130b.

The second embodiment described above includes a step of removing the binder contained in the first component CP1 and the support body SP by heating before the aggregate As is formed. Therefore, compared to a case where the binder contained in the first component CP1 and the support body SP is removed after the aggregate As is formed, the binder contained in the first component CP1 and the support body SP can be efficiently removed. In particular, the binder can be more efficiently removed in the vicinity of the bonding portion between the first component CP1 and the second component CP2. Therefore, when the degreasing of the first shaped object Md1 and the second component CP2 is simultaneously performed, a time required for degreasing of the first shaped object Md1 and the second component CP2 can be shortened.

### C. Third Embodiment

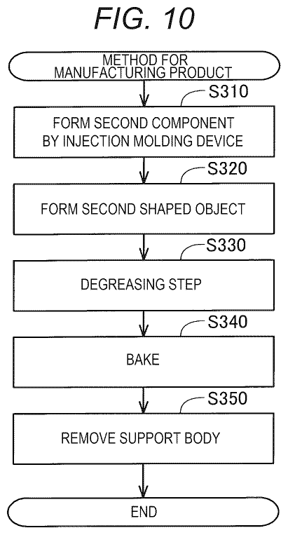

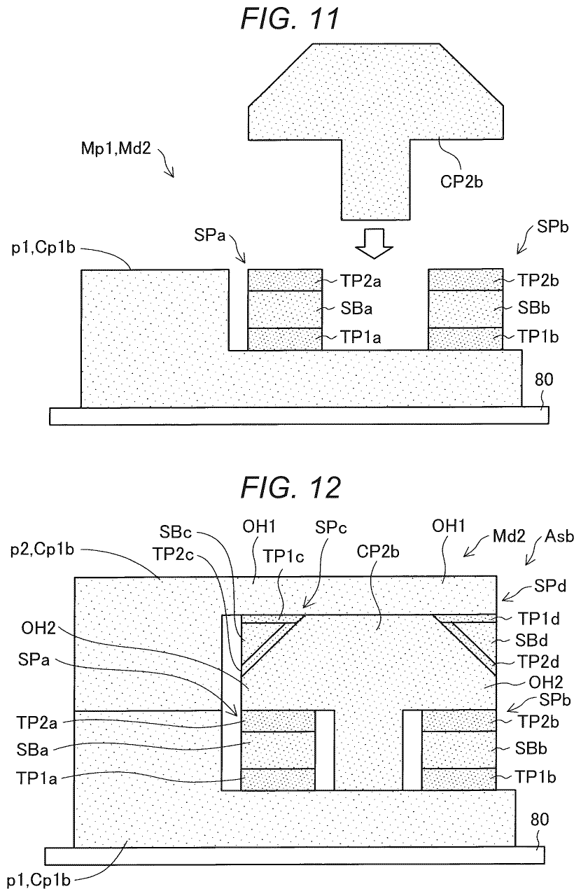

FIG. 10 is a process drawing showing a method for manufacturing a product according to a third embodiment. FIG. 11 is a first diagram showing a method for manufacturing a second shaped object Md2. FIG. 12 is a second diagram showing a method for manufacturing the second shaped object Md2. The method for manufacturing the product according to the embodiment includes a step of forming the second shaped object Md2 as a three-dimensional shaped object including a first component CP1b and a support body. The method for manufacturing the second shaped object Md2 includes a component arranging step described below. In a configuration of the manufacturing system 5 according to the third embodiment, portions not particularly described are the same as those in the first embodiment.

In step S310 of FIG. 10, a second component CP2b is prepared. In step S310 according to the embodiment, similarly to the first embodiment, the second component CP2b is formed by the injection molding machine 200. In step S320 of FIG. 10, as described above, the second shaped object Md2 is formed.

FIG. 11 shows a state in which the first component forming step is being executed halfway, and shows a halfway shaped object Mp1 that is the second shaped object Md2 shaped halfway. FIG. 12 shows the completed second shaped object Md2. Similarly to the first shaped object Md1 described in the first embodiment, the second shaped object Md2 is formed to take the same posture as the heating posture on the shaping stage 80. The halfway shaped object Mp1 includes a first portion p1 that is the first component CP1b formed halfway, a support body SPa, and a support body SPb. The support body SPa includes a support main body portion SBa, a first contact portion TP1a, and a second contact portion TP2a. The support body SPb includes a support main body portion SBb, a first contact portion TP1b, and a second contact portion TP2b. As shown in FIG. 11, the support body SPa and the support body SPb support an overhang portion OH2 of the second component CP2b from below.

The component arranging step described above is a step of arranging the second component CP2b prepared in advance on the first portion p1 in order to form an aggregate Asb, and is executed while the first component forming step is executed as shown in FIG. 11. FIG. 11 shows a state in which the second component CP2b prepared in step S310 of FIG. 10 is arranged on the first portion p1.

As shown in FIG. 12, the second shaped object Md2 is completed by shaping a portion Mp2 of the second shaped object Md2, which is shaped after the halfway shaped object Mp1, after the execution of the arranging step. The portion Mp2 includes a second portion p2, which is a portion of the first component CP1b to be shaped after the first portion p1, a support body SPc, and a support body SPd. The support body SPc includes a support main body portion SBc, a first contact portion TP1c, and a second contact portion TP2c. The support body SPd includes a support main body portion SBd, a first contact portion TP1d, and a second contact portion TP2d. As shown in FIG. 11, the support body SPc and the support body SPd support an overhang portion OH1 of the first component CP1b from below. As shown in FIG. 12, a part of the second portion p2 is formed above the second component CP2b. Therefore, in the second shaped object Md2, the second component CP2 is combined with the first component CP1b and the support bodies such that the second component CP2b is incorporated in the first component CP1b. More specifically, the second component CP2b is combined with the first component CP1b and the support bodies such that the second component CP2b is positioned between component parts of the first component CP1b in the vertical direction. In the embodiment, the second shaped object Md2 thus formed corresponds to the aggregate Asb.

Steps S330 to S350 in FIG. 10 are the same as steps S140 to S160 in FIG. 6, respectively. As described above, in the embodiment, since the second shaped object Md2 formed in step S320 corresponds to the aggregate Asb, a combining step is not executed after step S320.

According to the third embodiment described above, the arranging step of arranging the second component CP2b prepared in advance on the first portion p1 in order to form the aggregate Asb is executed during the execution of the first component forming step. Accordingly, in order to form an aggregate while the first component CP1b is being formed halfway, the second component CP2b can be combined with the first component CP1b formed halfway. Therefore, the second component CP2b can be easily incorporated into the first component CP1b. Since the combining step after the completion of the first component forming step can be shortened or omitted, the product can be manufactured more efficiently.

In the embodiment, after the completion of the component arranging step, at least a part of the second portion p2 is formed above the second component CP2b by the first component forming step. Therefore, a product having a more complicated shape can be easily manufactured.

In the embodiment, the second component CP2b is formed by the injection molding machine 200. Therefore, for example, the second component CP2b formed in a smaller and more complicated shape can be easily incorporated into the first component CP1b.

For example, it is also possible to form an aggregate by combining two or more second components with the first component or the support body. In this case, for example, the arranging step may be executed as in the third embodiment, and the formation of the second contact portion may be executed such that one surface thereof is in contact with the shaping stage 80 as in the first embodiment or the second embodiment. The arranging step may be executed as in the third embodiment, and the degreasing of the first component and the support body may be executed before the aggregate is formed as in the second embodiment.

### D. Other Embodiments

(D-1) In the above-described embodiment, the second component CP2 is formed by the injection molding machine 200. Regarding this, the second component CP2 may not be formed by the injection molding machine 200, and for example, may be shaped by three-dimensional shaping similarly to that of the first component CP1. In this case, for example, the second component CP2 may be shaped using the same device as the three-dimensional shaping device used for forming the first component CP1. In this case, for example, the three-dimensional shaping device may be formed to dispense the plasticized second material in addition to the plasticized first material and third material. The second component CP2 may be shaped using a device different from the three-dimensional shaping device used for forming the first component CP1. Accordingly, by bonding the first component CP1 and the second component CP2 formed by the three-dimensional shaping device, it is possible not only to manufacture the product PD having the complicated shape as described above, but also to manufacture, for example, a large product PD not limited to a size that can be shaped at a time by the three-dimensional shaping device.

(D-2) In the above-described embodiment, a pellet-shaped material is used for forming the first component CP1. Regarding this, a pellet-shaped material may not be used for forming the first component CP1, and for example, a filament material may be used. In this case, as described in the first embodiment, by making the mass ratios of the inorganic powder to the binder, in the material used for forming the first component CP1 and the second material, different from each other, for example, the mass ratio of the first inorganic powder to the binder in the material used for forming the first component CP1 can be easily adjusted such that the material maintains a filament shape. In another embodiment, the mass ratio of the first inorganic powder to the binder in the material used for forming the first component CP1 may be the same as the mass ratio of the second inorganic powder to the binder in the material used for forming the second component CP2.

(D-3) In the above-described embodiment, the particle size of the first inorganic powder and the particle size of the second inorganic powder are different from each other, but may be the same.

(D-4) In the above-described embodiment, the first component CP1 and the support main body portion SB are formed using the same material. Regarding this, as long as the first component CP1 and the support main body portion SB each contain the first inorganic powder and the binder, the first component CP1 and the support main body portion SB may be formed using different materials.

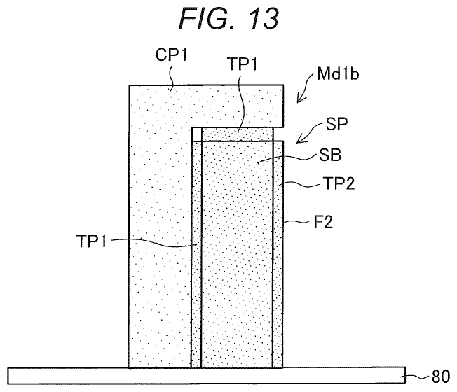

(D-5) In the above-described embodiment, the first shaped object Md1 and the second shaped object Md2 are shaped on the shaping stage 80 to take the same posture as the heating posture. Regarding this, the posture of the first component CP1 and the support body SP during shaping may be different from the heating posture. That is, the postures of the first component CP1 and the support body SP during shaping may be different from the postures of the first component CP1 and the support body SP in the aggregate As. For example, FIG. 13 is a diagram showing a state in which a shaped object Md3 having substantially the same shape as that of the first shaped object Md1 is shaped according to another embodiment. Unlike the first shaped object Md1, the shaped object Md3 is formed such that the one surface F2 of the second contact portion TP2 extends perpendicularly to the upper surface of the shaping stage 80. The first component CP1 and the support body SP may be formed in this manner. For example, the first component CP1 and the support body SP may be formed on the shaping stage 80 such that the first component CP1 and the support body SP take a posture vertically opposite to the heating posture.

(D-6) In the above-described embodiment, layers for forming the first contact portion TP1 and the second contact portion TP2 contain the third binder, but layers for forming the first contact portion TP1 and the second contact portion TP2 may not contain the binder. That is, the material for forming these layers may not contain the binder.

(D-7) In the above-described embodiment, a bonding surface between the first component CP1 and the second component CP2 is along a horizontal surface. Regarding this, the bonding surface between the first component CP1 and the second component CP2 may not be along the horizontal surface, and for example, may intersect with the horizontal surface.

(D-8) In the above-described embodiment, a combining step and a removal step are executed by a robot. Regarding this, the combining step and the removal step may be executed, for example, by hands of an operator.

(D-9) In the above-described embodiment, a material extrusion method of stacking the plasticized materials is described as an example, but the present disclosure can be applied to various methods such as a binder jet method and a material jet method.

### E. Other Embodiments

The present disclosure is not limited to the above-described embodiments, and can be implemented in various aspects without departing from the spirit of the present disclosure. For example, the present disclosure can be implemented in the following aspects. In order to solve a part of or all of problems of the present disclosure, or to achieve a part of or all of effects of the present disclosure, technical features of the embodiments described above corresponding to technical features in the following aspects can be replaced or combined as appropriate. Unless the technical features are described as essential technical features in the specification, the technical features can be deleted as appropriate.

(1) According to an aspect of the present disclosure, a method for manufacturing a three-dimensional shaped object is provided. The method for manufacturing a three-dimensional shaped object includes: a first component forming step of stacking a layer containing a first inorganic powder and a first binder to form a first component, the first component being bonded to a second component containing a second inorganic powder and a second binder by a heat treatment; and a support body forming step of forming, by stacking the layer, a support body, which is removed after the heat treatment, integrally with the first component. The heat treatment is executed on an aggregate in which the first component, the second component, and the support body are combined to be in contact with one another. In the aggregate, at least one of the first component and the second component includes an overhang portion overlapping with the other component from above, the overhang portion being spaced apart from the other component in a vertical direction. In the support body forming step, the support body is formed in the aggregate to support the overhang portion from below between the first component and the second component. The support body forming step includes: a first step of forming, by stacking the layer containing the first inorganic powder and the first binder, a support main body portion that is a portion of the support body being not in contact with the first component and the second component in the aggregate; a second step of forming, by stacking a layer containing a third inorganic powder, a first contact portion that is a portion of the support body being in contact with the first component in the aggregate; and a third step of forming, by stacking the layer containing the third inorganic powder, a second contact portion that is a portion of the support body being in contact with the second component in the aggregate. A melting point of the third inorganic powder is higher than a melting point of the first inorganic powder and a melting point of the second inorganic powder.

According to the aspect, the support body can be formed integrally with the first component to support the overhang portion in the aggregate. Since the support main body portion contains the first inorganic powder similarly to that of the first component, the first component and the second component can be bonded to each other by the heat treatment while maintaining a state in which the overhang portion is effectively supported by the support body. Since the first contact portion and the second contact portion contain the third inorganic powder having the melting point higher than the melting points of the first inorganic powder and the second inorganic powder, it is possible to obtain a product by easily removing the support body after the first component and the second component are bonded by the heat treatment. Therefore, it is possible to prevent a decrease in dimensional accuracy of the product due to deformation of the overhang portion caused by the heat treatment.

(2) In the above aspect, in the third step, the second contact portion may be formed such that one surface of the second contact portion is in contact with an upper surface of a shaping stage, in the first step, the support main body portion may be formed at the formed second contact portion, and in the aggregate, the one surface may form a contact surface of the second contact portion with the second component. According to the aspect, in the third step, the one surface of the second contact portion can be formed in a planar shape along the upper surface of the shaping stage. In the aggregate, since the second contact portion is in contact with the second component via the one surface, the second component can be effectively supported by the support body during sintering.

(3) In the above aspect, the first inorganic powder and the second inorganic powder may be each made of an inorganic material containing the same element as a main component. According to the aspect, the first component and the second component can be bonded to each other without using solder or the like at a bonding portion between the first component and the second component. Therefore, it is possible to prevent a decrease in strength of the bonding portion of the product.

(4) In the above aspect, a mass ratio of the first inorganic powder to the first binder in a material used for forming the first component may be different from a mass ratio of the second inorganic powder to the second binder in a material used for forming the second component. According to the aspect, a mass ratio of an inorganic powder to a binder in a material used for forming each component can be optimized according to a shape, a size, a forming method, or the like of each component.

(5) In the above aspect, a particle size of the first inorganic powder may be different from a particle size of the second inorganic powder. According to the aspect, thermal shrinkage amounts of the first component and the second component during the sintering can be adjusted by adjusting the particle sizes of the inorganic powders.

(6) In the above aspect, the first component and the support main body portion may be formed using the same material. According to the aspect, the number of types of materials to be used can be reduced as compared with a case where the first component and the support main body portion are formed of different materials.

(7) In the above aspect, the method for manufacturing a three-dimensional shaped object may include: removing the first binder contained in the first component and the first binder contained in the support body by heating before forming the aggregate. According to the aspect, compared to a case where the binder contained in the first component and the support body is removed after the aggregate is formed, the binder contained in the first component and the support body can be efficiently removed.

(8) In the above aspect, the method for manufacturing a three-dimensional shaped object may include: a component arranging step of arranging the second component prepared in advance on a first portion which is the first component formed halfway to form the aggregate, the component arranging step being executed while the first component forming step is executed. According to the aspect, in order to form the aggregate while the first component is being formed halfway, the second component can be combined with the first component formed halfway. Therefore, the second component can be easily incorporated into the first component.

(9) In the above aspect, after completion of the component arranging step, at least a part of a second portion of the first component, which is a portion formed after the first portion is formed, may be formed above the second component by the first component forming step. According to the aspect, a product having a more complicated shape can be easily manufactured.

(10) In the above aspect, the second component may be formed by an injection molding machine. According to the aspect, the second component formed in a smaller and more complicated shape by injection molding can be easily incorporated into the first component.

What is claimed is:

1. A method for manufacturing a three-dimensional shaped object, the method comprising:
a first component forming step of stacking a layer containing a first inorganic powder and a first binder to form a first component, the first component being bonded to a second component containing a second inorganic powder and a second binder by a heat treatment; and
a support body forming step of forming, by stacking the layer, a support body, which is removed after the heat treatment, integrally with the first component, wherein
the heat treatment is executed on an aggregate in which the first component, the second component, and the support body are combined to be in contact with one another,
in the aggregate, at least one of the first component and the second component includes an overhang portion overlapping with the other component from above, the overhang portion being spaced apart from the other component in a vertical direction,
in the support body forming step, the support body is formed in the aggregate to support the overhang portion from below between the first component and the second component,
the support body forming step includes
a first step of forming, by stacking the layer containing the first inorganic powder and the first binder, a support main body portion that is a portion of the support body being not in contact with the first component and the second component in the aggregate,
a second step of forming, by stacking a layer containing a third inorganic powder, a first contact portion that is a portion of the support body being in contact with the first component in the aggregate, and
a third step of forming, by stacking the layer containing the third inorganic powder, a second contact portion that is a portion of the support body being in contact with the second component in the aggregate, and
a melting point of the third inorganic powder is higher than a melting point of the first inorganic powder and a melting point of the second inorganic powder.

2. The method for manufacturing a three-dimensional shaped object according to claim 1, wherein
in the third step, the second contact portion is formed such that one surface of the second contact portion is in contact with an upper surface of a shaping stage,
in the first step, the support main body portion is formed at the formed second contact portion, and
in the aggregate, the second contact portion is in contact with the second component via the one surface.

3. The method for manufacturing a three-dimensional shaped object according to claim 1, wherein
the first inorganic powder and the second inorganic powder are each made of an inorganic material containing the same element as a main component.

4. The method for manufacturing a three-dimensional shaped object according to claim 1, wherein
a mass ratio of the first inorganic powder to the first binder in a material used for forming the first component is different from a mass ratio of the second inorganic powder to the second binder in a material used for forming the second component.

5. The method for manufacturing a three-dimensional shaped object according to claim 1, wherein
a particle size of the first inorganic powder is different from a particle size of the second inorganic powder.

6. The method for manufacturing a three-dimensional shaped object according to claim 1, wherein
the first component and the support main body portion are formed using the same material.

7. The method for manufacturing a three-dimensional shaped object according to claim 1, further comprising:
removing the first binder contained in the first component and the first binder contained in the support body by heating before forming the aggregate.

8. The method for manufacturing a three-dimensional shaped object according to claim 1, further comprising:
a component arranging step of arranging the second component prepared in advance on a first portion which is the first component formed halfway in order to form the aggregate, the component arranging step being executed during the execution of the first component forming step.

9. The method for manufacturing a three-dimensional shaped object according to claim 8, wherein
after completion of the component arranging step, at least a part of a second portion of the first component, which is a portion formed after the first portion is formed, is formed above the second component by the first component forming step.

10. The method for manufacturing a three-dimensional shaped object according to claim 8, wherein
the second component is formed by an injection molding machine.
